(19) United States
(12) Patent Application Publication
(10) Pub. No.: US 2025/0267686 A1
(43) Pub. Date: Aug. 21, 2025

(54) Beacon Based Network Device Management

(71) Applicant: Vivint LLC, Provo, UT (US)

(72) Inventors: Jonathan Evans, Provo, UT (US); Craig Matsuura, Provo, UT (US); Daniel Albl, Provo, UT (US)

(73) Assignee: Vivint LLC, Provo, UT (US)

(21) Appl. No.: 19/058,247

(22) Filed: Feb. 20, 2025

Related U.S. Application Data
(60) Provisional application No. 63/555,744, filed on Feb. 20, 2024.

(51) Int. Cl. H04W 72/30; H04W 12/04; H04W 12/06; H04W 48/10

(52) U.S. Cl. CPC H04W 72/30; H04W 12/04; H04W 12/068; H04W 48/10

(57) ABSTRACT

Systems and methods for beacon-based network management are disclosed. A first device is configured to transmit a broadcast message indicating a presence of a first network. The broadcast message can include credentials for a second network. A second device is configured to receive the broadcast message, retrieve the credentials for the second network, and access, via provision of the credentials to a third device, the second network.

### CROSS REFERENCE

This application claims priority to U.S. Provisional Patent Application, 63/555,744, filed Feb. 20, 2024, and entitled BEACON BASED NETWORK DEVICE MANAGEMENT, which is incorporated by reference herein in its entirety.

### TECHNICAL FIELD

The current disclosure generally relates to networking communications based on broadcast signals. More specifically, the current disclosure relates to systems and methods for command exchanges for network reassociation, device commands, or other network functionality.

### BACKGROUND

Network devices can communicate over a shared medium, such as a wireless medium. The wireless medium may be shared across various networks of a same or different types. For example, various basic service sets (BSS) of a wireless fidelity (Wi-Fi) network can be located in proximity to each other, such that messages transmitted from a device of a particular network may be received by a device which is not a member of the particular network (e.g., is a member of a different network or is not associated with a network). The various networks can restrict membership according to various criteria, including access credentials (e.g., a WPA/WPA2 passphrase or SSID).

Access credentials for a network can receive updates, such as according to a password expiration policy, network configuration changes, or so forth. However, some devices intended for network membership may not receive or retain updated credentials. For example, a device may be disabled during a credential update, may be “factory reset” to resolve another issue, or may be an additional module provided for inclusion in an existing network. Moreover, prior to initial association with a network, a device intended for operation with a network may lack credentials associated therewith.

### SUMMARY

Systems and methods for network association are disclosed. One embodiment relates to a system. The system includes a first device configured to transmit a broadcast message indicating a presence of a first Wi-Fi network, the broadcast message comprising credentials for a second Wi-Fi network. The system includes a second device. The second device can receive the broadcast message. The second device can receive the credentials for the second Wi-Fi network. The second device can access, via provision of the credentials, the second Wi-Fi network.

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is a block diagram of a system including network devices, according to an embodiment;

FIG. 2 is a block diagram of a network, according to an embodiment; and

FIG. 3 is a sequence diagram for a method of network association, according to an embodiment.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

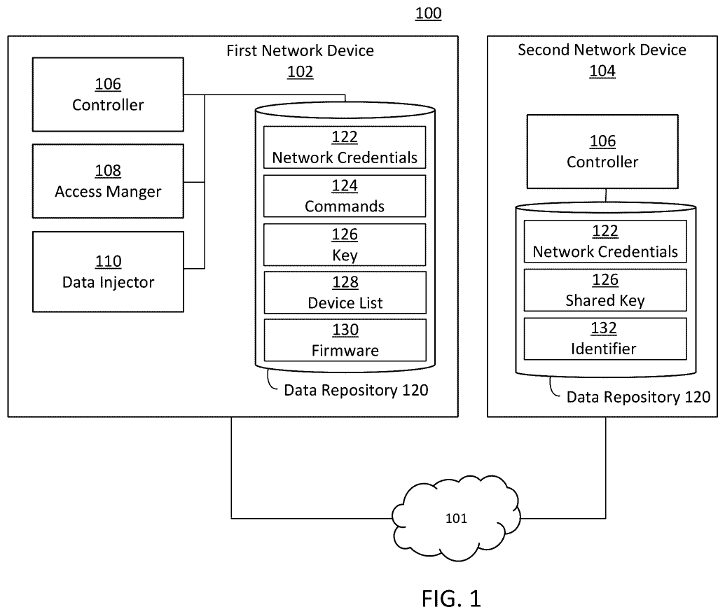

Turning now to FIG. 1, a system 100 including a first network device 102 and second network device 104 is provided, according to an embodiment. The network devices 102, 104 or aspects thereof can be or include (but are not limited by) any devices in a networked environment, such as a residential security system. For example, the devices can include such include cameras or other sensors, servers, routers, switches, and/or other networking equipment. The cameras or other sensors (e.g., radar sensors, microphones, door sensors, window sensors, or other sensors) may be configured to detect a breach of security event for which the respective sensors are configured. A user interface may be installed or otherwise located at the building. The user interface may be part of or executed by a device, such as a mobile phone, a tablet, a laptop, wall panel, or other device. The user interface may connect to the cameras or other sensors (or other networked devices) via the network 101. The user interface may aid a user to access sensor data of the cameras or other sensors. The user interface may receive indications of a device list 128. For example, a user interface may receive an indication of a number of devices which exceeds a number of devices in network communication with the user interface (e.g., devices which have lost connectivity or not yet been connected to the network). The network devices 102, 104 can include an AP device configured to provide credentials to another device, or another STA configured to associate with a network responsive to such communications.

The various devices of the system 100 can employ a network 101 to exchange information. The network 101 can include a local network and/or another network 101, such as a mobile telephone network. The (e.g., local) network 101 may employ a Wi-Fi network based on any one of the Institute of Electrical and Electronics Engineers (“IEEE”) 802.11 standards. The network may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the network 101 may employ ZigBee® connectivity based on the IEEE 802 standard and may include one or more ZigBee connections. The network 101 may include a ZigBee® bridge. In some implementations, the network 101 employs Z-Wave® connectivity as designed by Sigma Designs® and may include one or more Z-Wave connections. The network 101 may employ an ANT® and/or ANT+® connectivity as defined by Dynastream® Innovations Inc. of Cochrane, Canada and may include one or more ANT connections and/or ANT+ connections.

The network 101 can include an AP configured to exchange data with non-AP STA devices. References to a particular device as an AP or STA (e.g., non-AP STA) are not intended to limit the device to such a mode of operation. For example, some devices can operate as either or both of an AP and non-AP STA device (e.g., according to a mode of operation). For example, some devices can operate as an AP to advertise a presence or provide a payload including a predefined command or network credential 122 in a beacon frame in a first mode of operation and operate as a non-AP STA device in a second mode of operation. The network 101 can include computer networks 101 such as wireless fidelity (Wi-Fi) networks, Peripheral Component Interconnect Express (PCIe), the Internet, local, wide, metro, or other area networks 101, intranets, cellular networks, satellite networks, and other communication networks 101 or data mobile telephone networks. The network can be public or private. The various elements of the system 100 can communicate over the network 101.

The system 100 can include or interface with any number of network devices, such as the depicted first network device 102 and second network device 104. One or more of the network devices can include interface with at least one controller 106. One or more of the network devices can include interface with at least one access manager 108 to manage access to a network 101. One or more of the network devices can include a data injector 110 to inject data into a beacon frame for provision to further devices. The controller 106, access manager 108, or data injector 110 can each include at least one processing unit or other logic device such as programmable logic array engine, or module configured to communicate with the data repository 120 or database. The controller 106, access manager 108, or data injector 110 can be separate components, a single component, or part of the system 100.

The data repository 120 can include one or more local or distributed databases, and can include a database management system. The data repository 120 can include computer data storage or memory and can store one or more data structures (e.g., a separate data structure corresponding to each device of the system). The data structures can include, for example, network credentials 122, commands 124, keys 126, device lists 128, firmware 130 versions, or identifiers 132.

A network credential 122 can refer to or include a credential used to establish membership in, communicate with, or otherwise interface with other network devices. For example, in a Wi-Fi network, the network credential 122 can include an SSID or password corresponding thereto (e.g., Wireless Protected Access (WPA1, 2, 3, etc.) or Wi-Fi protected Setup (WPS) key 126.

A command 124 can refer to or include a predefined instruction to execute an action. For example, a command 124 can include a command 124 to associate with a network (e.g., an AP of a BSS), update a firmware 130 version, or provide a token (e.g., the key 126 or identifier 132), or other token to receive network credentials 122. The command 124 can include or accompany a cryptographic key 126 or identifier 132, as in the case of a cryptographic key 126 or identifier 132 of an AP device. The network credential 122 or command 124 may be indicated by any portion of the beacon frame, such as an SSID field, or a vendor specific field.

A key 126 can refer to or include a cryptographic key 126 of a symmetric cryptographic function (e.g., a shared key 126), a key 126 of a key pair of an asymmetric cryptographic function, a one-time key 126 (e.g., session key 126), or the like.

A device list 128 can refer to or include a list of unique or non-unique devices for associated with a network 101. For example, in some embodiments, the device list 128 can refer a list of unique devices which have previously connected with a network, according to a unique identifier 132 thereof. In some embodiments, the device list can refer to a set of devices which are permitted to access a network (e.g., an access list). Such an access list can be according to a manufacturer, MAC address range, or so forth. In some embodiments, the device list 128 can include devices according to a provision of a key 126 from the device or another device (e.g., an indication from a server that a device should be included in a device list 128). For example, a server can provide a device identifier 132 for a device which is intended for connection to a network 101 (e.g., upon purchasing or registering a Wi-Fi equipped camera, a registration server can provide an update of the device list for the network 101).

Firmware 130 can refer to or include a version of instructions which are configured to cause a device to connect to a network 101. In some embodiments, firmware 130 may be updated in situ, or may be reverted to a previous version (e.g., a factory reset). In some embodiments, some firmware 130 revisions may add or deprecate functionality (e.g., mixed-mode WPA2-WPA3 operation). For example, a firmware 130 revision may deprecate support for WPA2, wherein another device may not support WPA3, such that the WPA2 device may not associate with a network 101 including a WPA3 only AP.

An identifier 132 can refer to or include an indication of identity, such as an electronic token, version number, manufacturer, model number, or other indication of identity which can be provided between various network devices. Some identifiers 132 can be or include unique identifiers 132, (e.g., MAC address, serial number, index numbers).

The system 100 can include or interface with at least one controller 106. The controller 106 can include or interface with one or more processors and memory. The processor can be implemented as a specific purpose processor, an application specific integrated circuit (ASIC), one or more field programmable gate arrays (FPGAs), a group of processing components, or other suitable electronic processing components. The processors and memory can be implemented using one or more devices, such as devices in a client-server implementation. The memory can include one or more devices (e.g., random access memory (RAM), read-only memory (ROM), flash memory, hard disk storage) for storing data and computer code for completing the various operations described herein. The memory can be or include volatile memory or non-volatile memory and can include database components, object code components, script components, or any other type of information structure for supporting the various activities and information structures of the present disclosure. The memory can be communicably connected to the processor and include computer code or instruction modules for executing one or more processes described herein. The memory can include various circuits, software engines, and/or modules that cause the processor to execute the systems and methods described herein.

The controller 106 can include or be coupled with communications electronics. The communications electronics can conduct wired and/or wireless communications. For example, the communications electronics can include one or more wired (e.g., Ethernet, PCIe, or AXI) or wireless transceivers (e.g., a Wi-Fi transceiver, an NFC transceiver, or a cellular transceiver). The communications electronics can couple the controller 106 with one or more elements of the system 100. For example, the communications electronics can include Wi-Fi transceivers configured to communicate between the various network devices. The controller 106 can exchange information (e.g., commands or status information) between networked devices via the communications electronics. The controller 106 can cause one or more operations disclosed, such as by employing another element of the system 100. Operations disclosed by other elements of the system 100 can be initiated, scheduled, or otherwise controlled by the controller 106. For example, the controller 106 can instantiate the access manager 108 and data injector 110.

The system 100 can include or interface with at least one access manager 108. The access manager 108 can maintain a device access list for access to a network 101. For example, the access manager 108 can determine whether a network device should be included in a device list 128 for access to a network 101. In some embodiments, the access manager 108 can receive an input to add a device to the network 101 (e.g., locally from a user via a user interface, from a remote server, or from another network connected device, such as a mobile device). The input can identify a particular device (e.g., according to an identifier 132 thereof) or can omit an indication of identity. For example, the indication can cause the network device to transmit a broadcast frame (e.g., a beacon frame) for a predefined time.

Subsequent to provision of the broadcast frame, the access manager 108 can associate with one or more devices, such as the depicted second network device 104. For example, the second network device 104 can provide network credentials 122 to the first network device based on the receipt of the broadcast frame. In some instances, such credentials may have been received from the beacon frame (e.g., encrypted according to a shared secret between the first network device 102 and second network device 104). In some instances, such credentials may be retrieved, by the second network device 104, from the information included in the beacon frame. For example, the second network device 104 can employ a key 126 saved in memory to decrypt the credentials from the beacon frame. In some embodiments, the key 126 can be saved in firmware 130.

Upon association, the access manager 108 can determine that the second network device is or is not included in a device list 128. In some instances, the access manager 108 can add or remove a device from the access list. The addition or removal can be responsive to the provision of a token from the second network device or an indication from another server (e.g., a white-list or black-list of a credential, identifier 132, or other token.)

The system 100 can include or interface with at least one data injector 110 to inject data into a frame (e.g., the beacon frame). For example, the data injector 110 can inject network credentials 122 into a field of the beacon frame. In some embodiments, the data injector 110 can inject commands into the beacon frame. For example, commands can include commands to revert to a previous firmware 130 version, or to update a firmware 130 revision. In some embodiments, the commands can include commands to display a particular status (e.g., via a blinking LED or other user interface). In some embodiments, the command can include a command to establish a connection with a further device (e.g., a remote server) to retrieve an update or credentials. In some embodiments, the data injector 110 can provide a designator in the beacon frame. For example, the designator can provide a designation of an address for one or more receiving devices (e.g., all Wi-Fi cameras supporting such operation, a particular device model, a particular firmware revision, etc.).

In some embodiments, the data injector 110 can encrypt any data injected into a frame. For example, the data injector 110 can encrypt network credentials 122 (or commands 124) prior to injection into the beacon frame such that upon a receipt of the beacon frame, a device having a cryptographic key 126 corresponding to the encrypted data may decrypt the data with the key 126. In some embodiments, the encryption can be according to a same key 126 stored in various devices (e.g., devices of an access list, or all devices can store a same key 126, as in the case of a factory key 126 included in a factory firmware 130). In some embodiments, the encryption can be specific to a device identifier (e.g., a particular model number, production date, serial number, MAC address, or other serial number). In some embodiments, the data injector 110 can retrieve a key 126 from a remote server prior to encrypting the data. For example, the data injector 110 can receive, from the access manager 108, an indication that a device which is expected to be in network communication is not accessible via a wireless network. Responsive to the receipt of such an indication, the data injector 110 can retrieve a key 126 corresponding to the missing device and inject network credentials 122 corresponding to the key 126. For example, in the case of a symmetric key 126, the data injector 110 can retrieve a same key 126.

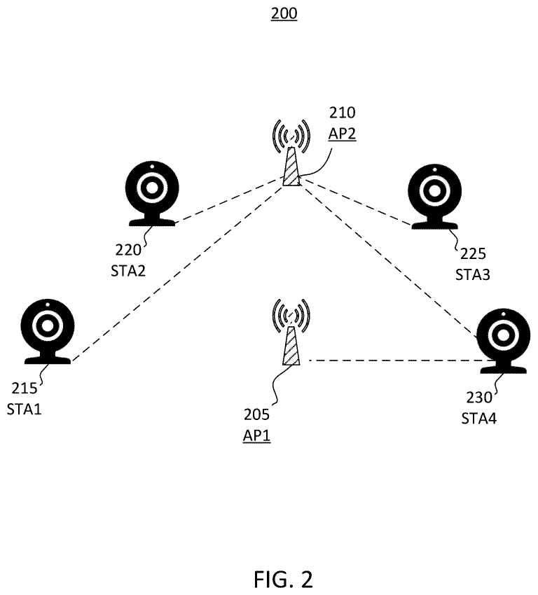

Turning now to FIG. 2, a block diagram of a network environment 200 is provided, according to an embodiment. The network environment 200 can include at least one access point 205 such as an AP of a Wi-Fi network, a Zigbee hub, or so forth. The access point 205 can communicate with various network stations (STAs) such as via broadcasting beacon messages including an SSID, whereupon a STA device can respond to the beacon with an authentication request, association request, and so forth. In some embodiments, the access point 205 can omit the SSID from the beacon frame, wherein the various STA devices can provide the SSID as a portion of the network credentials 122.

In some embodiments, the first AP 205 can be a router configured to operate with various STA of a network. For example, the first AP 205 can be a Wi-Fi router. In some embodiments, the first AP 205 can be separate from a router (e.g., may be a camera operating as an AP to provide an access credential to one or more devices). For example, the first AP 205 may not associate with any non-AP STA, but may instead provide beacon or other broadcast messages including credentials for a different network 101. The router (e.g., the second AP 210) can connect various network STA to a network (e.g., the internet). The various STA can include various mobile devices, tablets, laptops, or home security systems, or the like. For example, the depicted first STA 215, second STA 220 and third STA 225 can include Wi-Fi cameras as a part of a security network connected to the internet, via the second AP 210.

A fourth STA 230 may not be connected to a network. For example, the device may be intended for addition to a network, may have been factory reset, network credentials 122 may have been updated without informing the fourth STA 230, the fourth STA 230 may have corrupted memory contents including the credentials, etc. In some embodiments, the fourth STA 230 can include a headless device (e.g., lacking a display or including a basic user interface (e.g., an LED and/or button) which may render manual entry of network credentials 122 challenging. Moreover, the fourth STA 230 may be installed in a location which is difficult to access. The fourth STA 230 can be configured to receive (e.g., from the first AP 205), a network credentials 122 (or other commands 124) in a beacon frame. The fourth STA 230 can, based on such a receipt, perform an action. For example, the action can include associating with the second AP 210 based on a receipt of the credentials, updating or reverting a firmware 130 revision, clearing locally stored data, etc. The action may be performed without associating with the AP providing the beacon frame (e.g., the first AP 205).

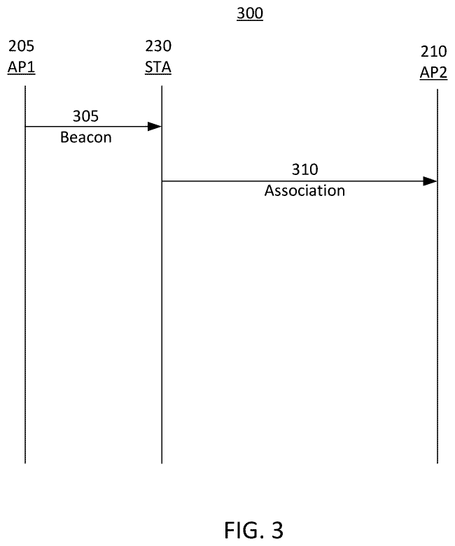

Referring now to FIG. 3, a sequence diagram 300 is provided. At operation 305, a STA receives a beacon frame from a first AP 205. The beacon frame may be provided, by the first AP 205, at a regular interval or responsive to a determination that a device on a device list 128 is not connected to a network. For example, the AP can identify the device as a device which was previously connected to the network or based on another indication that a device should be present such as an indication received from a mobile device, remote server, etc. In some embodiments, the beacon frame may be provided for a limited period responsive to a user command (e.g., an association pushbutton of the AP). For example, the first AP 205 can be configured to halt broadcasting the beacon frames at an expiration of a predefined interval or upon receiving an indication of the association of the STA with the second AP 210 (e.g., the first AP 205 may operate as a non-AP STA of the second AP 210).

At operation 310, based on the receipt of the beacon frame, the STA device (e.g., the fourth STA 230 of FIG. 2) associates with another AP. The associated AP can differ from the AP the beacon frame is received from. For example, the beacon frame may be received from a first AP 205 (e.g., a camera), and based on the receipt of such a beacon frame, the STA can associate with a second AP 210 (e.g., a router). Thus, a router acting as an AP for a local network can associate with a STA device without performing additional operations, wherein another network device (which may also operate as a non-AP STA of the router) can provide the network credentials.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer or service or entirely on the remote computer or server or set of servers. In the latter scenario, the remote computer may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A system comprising:
a first device configured to:
transmit a broadcast message indicating a presence of a first Wi-Fi network, the broadcast message comprising credentials for a second Wi-Fi network; and
a second device configured to:
receive the broadcast message;
retrieve the credentials for the second Wi-Fi network; and
access, via provision of the credentials to a third device, the second Wi-Fi network.

2. The system of claim 1, wherein the first device is configured to transmit the broadcast message responsive to a determination that the second device is absent from the second Wi-Fi network.

3. The system of claim 2, wherein:
the first device is configured to maintain a list of devices connected to the first Wi-Fi network; and
the determination that the second device is absent from the second Wi-Fi network comprises:
a determination that the second device was previously connected to the second Wi-Fi network at a first time; and
a determination that the credentials for the second Wi-Fi network differ from prior credentials at the first time.

4. The system of claim 1, wherein the broadcast message comprises:
an indication for the second device to update a firmware version.

5. The system of claim 1, wherein the broadcast message includes a designator for a plurality of second devices.

6. The system of claim 1, wherein:
the broadcast message comprises an encrypted portion for the credentials;
the first device includes an encryption key to encrypt the credentials; and
the second device includes a decryption key to decrypt the credentials.

7. The system of claim 1, wherein the first device is configured to withhold an authentication response, responsive to an authentication request received responsive to the broadcast message.

8. The system of claim 1, wherein:
the third device is an AP device; and
the first device is a STA associated with third device.

9. A method comprising:
transmitting, by a first device, a broadcast message indicating a presence of a first Wi-Fi network, the broadcast message comprising credentials for a second Wi-Fi network; and
receiving, by a second device, the broadcast message;
retrieving, by the second device, the credentials for the second Wi-Fi network; and
accessing, via provision of the credentials by the second device to a third device, the second Wi-Fi network.

10. The method of claim 9, wherein transmitting the broadcast message is responsive to a determination that the second device is absent from the second Wi-Fi network.

11. The method of claim 10, further comprising:
maintaining, by the first device, a list of devices connected to the first Wi-Fi network; and
wherein the determination that the second device is absent from the second Wi-Fi network comprises:
determining that the second device was previously connected to the second Wi-Fi network at a first time; and
determining that the credentials for the second Wi-Fi network differ from prior credentials at the first time.

12. The method of claim 9, wherein the broadcast message comprises:
an indication for the second device to update a firmware version.

13. The method of claim 12, wherein the broadcast message includes a designator for a plurality of second devices.

14. The method of claim 12, wherein:
the broadcast message comprises an encrypted portion for the credentials;
the first device includes an encryption key to encrypt the credentials; and
the second device includes a decryption key to decrypt the credentials.

15. The method of claim 12, further comprising withholding, by the first device, an authentication response responsive to an authentication request received responsive to the broadcast message.

16. An apparatus comprising:
a device configured to:
receive a broadcast message indicating a presence of a first Wi-Fi network, the broadcast message comprising a credential for a second Wi-Fi network;
retrieve the credentials for the second Wi-Fi network; and
access, via provision of the credentials to a third device, the second Wi-Fi network.

17. The apparatus of claim 16, wherein the device is configured to transmit the broadcast message responsive to a determination that a second device is absent from the second Wi-Fi network.

18. The apparatus of claim 17, wherein:
the device is configured to maintain a list of devices connected to the first Wi-Fi network; and
the determination that the second device is absent from the second Wi-Fi network comprises:
a determination that the second device was previously connected to the second Wi-Fi network at a first time; and
a determination that the credentials for the second Wi-Fi network differ from prior credentials at the first time.

19. The apparatus of claim 16, wherein the broadcast message comprises:
an indication for a second device to update a firmware version.

20. The apparatus of claim 16, wherein the broadcast message includes a designator for a plurality of second devices.
